(19) United States
(12) Patent Application Publication
(10) Pub. No.: US 2003/0036984 A1
(43) Pub. Date: Feb. 20, 2003

(54) Method and system for maintaining efficient material inventory

(76) Inventors: Hung-Liang Chiu, Taipei (TW); Duncan Ta-Te Lin, Taipei (TW); Ming-Fen Lee, Taipei (TW)

Correspondence Address: FULBRIGHT & JAWORSKI L.L.P., M. John Carson, Twenty-Ninth Floor, 865 South Figueroa, Los Angeles, CA, 90017-2571, US

(21) Appl. No.: 10/216,480

(22) Filed: Aug. 9, 2002

(30) Foreign Application Priority Data
Aug. 13, 2001 (TW) 90119742

(51) Int. Cl. G06F 17/60

(52) U.S. Cl. 705/28

(57) ABSTRACT

A method and a system for maintaining efficient material inventory are proposed, in which data related to material stock and product orders from overseas manufactories of an enterprise are stored into a database server through a network such as internet or intranet, and the stored data are processed and integrated to generate a report of current material inventory conditions, so as to manage and procure materials according to the report for maintaining safe material inventory. This allows the enterprise to immediately monitor and control material stock quantity in its manufactories, so as to maintain sufficient material inventory for supporting prompt and timely product delivery in response to client orders, and to effectively organize and manage material stock of the manufactories for reducing capital costs.

### FIELD OF TIE INVENTION

The present invention relates to methods and systems for controlling material inventory, and more particularly, to a method and a system for maintaining efficient material inventory, in which data relating to material inventory and product orders of overseas manufactories of a business enterprise are uploaded to a network server, so as to integrate and process the data for presenting a current inventory status of materials, which can be retrieved by a user through the use of a browser of a terminal device.

### BACKGROUND OF THE INVENTION

Nowadays, confining the business activities locally can no longer satisfy business expansion and profit need unless a network of overseas manufacturing factories and a network of warehouses are established in order to facilitate economical, quick and timely delivery of products to customers.

For successful business, an adequate inventory control of materials that are used in the manufactories for producing finished products is highly essential. However, maintaining an adequate inventory constitutes one of the most significant expenses for staying in business. For example, inadequate inventory such as over storage of materials and finished products can tie up operating capital for long periods of time and hinder the opportunity for the business to make needed improvements, such as expansion, advertising, hiring additional employees, and the like. On the other hand, shortage of materials can cause frequent shut down of the manufactories, and shortage of finished products can definitely cause customer's dissatisfaction leading the business to catastrophe. Besides, the transportation of the materials between the network of manufactories could also delay the speed of delivery of finished products to the customers and the storage of materials.

Accordingly, it is highly desirable to develop a more efficient inventory of materials and products to reduce unnecessary outlays of capital. It is also highly desirable to develop a method and a system which can automatically and accurately satisfy the replenishment of inventory of materials and products for storage to assure that the warehouse of the business enterprise are regularly stocked with a suitable number of items based upon anticipated demand, whereby to avoid overstocking or running low of inventory of materials and products for any prolonged period of time, so that smooth operation of the network of manufactories and customer satisfaction can be maintained while this would allow a further business expansion and profits leading to a successful business.

### SUMMARY OF THE INVENTION

A primary objective of the present invention is to provide a new method and a system for maintaining efficient material inventory, allowing an enterprise to effectively control material usage and operation in overseas manufactories, so as to provide immediate delivery of products to clients, and desirably reduce stock of materials and products.

Another objective of the invention is to provide a method and a system for maintaining efficient material inventory, which allow material communication between an enterprise and manufactories at overseas locations, so as to effectively control stock of materials and products, thereby making product delivery quick and timely processed.

In accordance with the above and other objectives, the present invention proposes a method and a system for maintaining efficient material inventory. The system for maintaining efficient material inventory includes a network server, a database server and a terminal device. First, a user at the terminal device uploads data related to material stock and product orders from overseas manufactories of an enterprise to the network server; the network server processes the uploaded data and stores the processed data into the database server. The network server regularly retrieves data from the database server, and calculate and integrate the data for generating a report of current material inventory conditions to be stored in a database of the network server, allowing the user at the terminal device to retrieve the stored report of material inventory conditions from the network server, and to properly organize production schedule and material procurement without causing any undesirable effect on production yield.

In the use of the system for maintaining efficient material inventory of the invention, for proceeding the method for maintaining efficient material inventory, first, a data uploading process is performed for uploading data to a network server and a database server. That is, a user at a terminal device can upload data related to material stock and product orders from overseas manufactories of an enterprise through the use of a data uploading form displayed in a browser of the terminal device and transmitted from the network server. The data uploading form with data inputted by the user is then transmitted through intranet or internet to the network server. Then, the network server transmits the uploaded data to the database server for data processing. Upon receiving data from the network server, the database server processes the data and stores the processed data in a database thereof

For retrieving a material inventory report, the user at the terminal device submits a report retrieval request to the network server through the browser of the terminal device and intranet or internet, so as to prompt the network server to retrieve and transmit the requested material inventory report to the user.

Before downloading the material inventory report, the network server regularly retrieves data related to material stock and product orders from the database of the database server, so as to calculate and integrate the retrieved data, and to store the data in a report database of the network server, for allowing the user to retrieve desired data.

In addition, the user at the terminal device can input inquiry data items and conditions through intranet or internet to an inquiry inputting form displayed in the browser and transmitted from the network. server, and the inquiry inputting form with inputted data is transmitted to the network server. Then, the network server retrieves corresponding material inventory data from the report database according to the inquiry data items and conditions.

Therefore, the method and system for maintaining efficient material inventory of the invention, through internet or intranet, allow an enterprise to immediately monitor and control material stock quantity in its overseas manufactories, so as to maintain sufficient material inventory for supporting prompt and timely product delivery in response to client orders, and to effectively organize and manage material stock of the manufactories for reducing capital costs.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram showing basic architecture of a system for maintaining efficient material inventory of the invention;

FIG. 2 is a schematic diagram of data uploaded by a user;

FIG. 3 is a schematic diagram showing a method for maintaining efficient material inventory in the use of a system for maintaining efficient material inventory of the invention;

FIG. 4 is a schematic diagram showing detailed procedures for describing a proceeding step in FIG. 3;

FIG. 5 is a schematic diagram showing another embodiment of detailed procedures for describing a proceeding step in FIG. 3;

FIG. 6 is a schematic diagram showing detailed description of FIG. 5 after step S31;

FIG. 7 is a schematic diagram showing a practical example of a display page operated by a user in the use of a method and a system for maintaining efficient material inventory of the invention; and

FIG. 8 is a schematic diagram showing a practical example of displayed material inventory report in the use of a method and a system for maintaining efficient material inventory of the invention.

### DETAILED DESCRIPTION OF THE PREFERRED EMBODIMENTS

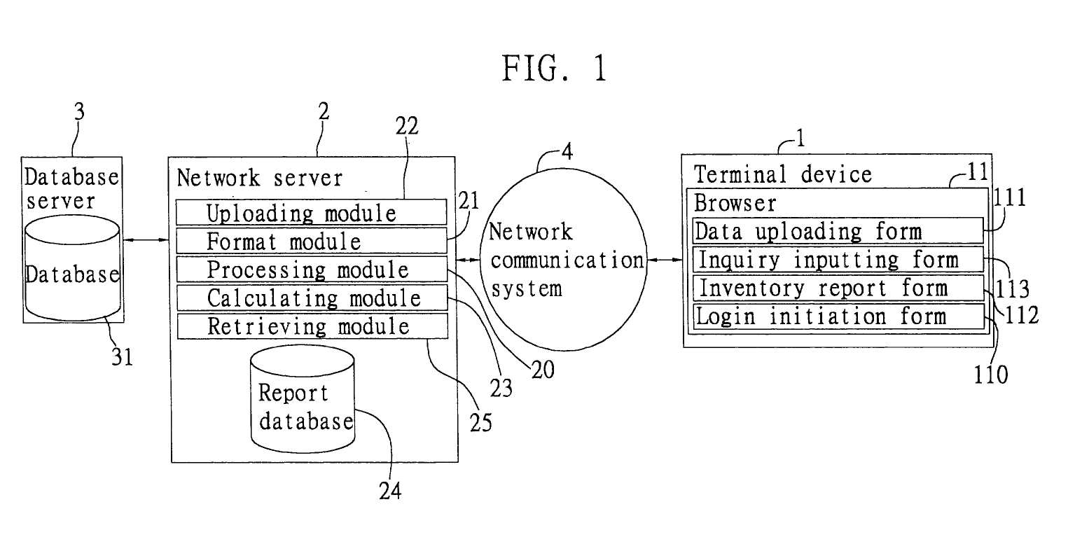

Referring to FIG. 1, it illustrates basic architecture of a system for maintaining efficient material inventory of the present invention. As shown in the drawing, the system for maintaining material efficient inventory comprises a terminal device 1, a network server 2 and a database server 3.

The terminal device 1 includes a browser 11, allowing a user to use the browser 11 for establishing connection with the network server 2 through a network communication system 4. The browser 11 of the terminal device 1 receives various forms (described in more detail thereinafter) from the network server 2, so as to retrieve or search material inventory data, or upload stock and order data of materials and products information from overseas manufactories of an enterprise. In response, corresponding results are displayed in the forms of the browser 11.

The network server 2 generates various forms in response to requests of the user who logs in the network server 2. The network server 2 includes a processing module 20, a form module 21, an uploading module 22, a calculating module 23, a report database 24 and a retrieving module 25.

The processing module 20 is used to receive requests from the user who logs in the network server 2, e.g. requests for uploading data, retrieving material inventory reports, checking inventory status of materials or products, and so on (described in detail later on). According to the user's requests, the processing module 20 retrieves corresponding forms from the form module 21 and transmits them to the terminal device 1. Further, the processing module 20 can also retrieve data in forms transmitted from the terminal device 1, e.g. data of inquiry items inputted for inquiring material inventory status, and transmit the retrieved data to the retrieving module 25 for data processing. Then, the processing module 20 obtains corresponding forms from the form module 21, and transmits the forms with the processed data to the terminal device 1.

The form module 21 includes a variety of forms to be retrieved by the processing module 20, so as to provide corresponding forms for the user to retrieve or inquire inventory status of materials and products and to upload data.

The uploading module 22 receives uploaded data from the processing module 20, and transmits the uploaded data to the database server 3 for storing the data in a database 31.

The calculating module 23 regularly retrieves data from the database 31 of the database server 3, and processes the retrieved data so as to store material inventory status obtained from the processed data into the report database 24.

The report database 24 is designed to store data related to the inventory of materials and products generated by the calculating module 23 that processes data stored in the database 31 of the database server 3.

The retrieving module 25 is used for receiving the inquiry of material inventory data from the processing module 20, and retrieving the inquired data from the report database 24.

The database server 3 includes a database 31 for storing data uploaded from the uploading module 22, allowing the calculating module 23 to retrieve the stored data from the database 31 for data processing.

In more detail, the terminal device I is provided with a browser 11, allowing a user to use the browser 11 to submit a login request to the network server 2 through a network communication system 4 (intranet or internet). for establishing connection between the terminal device 1 and the network server 2. After a processing module 20 of the network server 2 receives the login request from the browser 11, it retrieves a login initiation form 110 for logging in the network server 2, and the login initiation form 110 is transmitted to and displayed in the browser 11 of the terminal device 1. Then, the user at the terminal device 1, for example, a sales staff or a production manager, keys in a login name or password for identification purpose into the login initiation form 110, which is then transmitted to the network server 2 through the network communication system 4, so as to control authorized access of the user to the network server 2. Since the identification step of user's authorization for accessing the network server 2 is compulsory and also well known to those skilled in the art, therefore, further details thereof are not to be described herein.

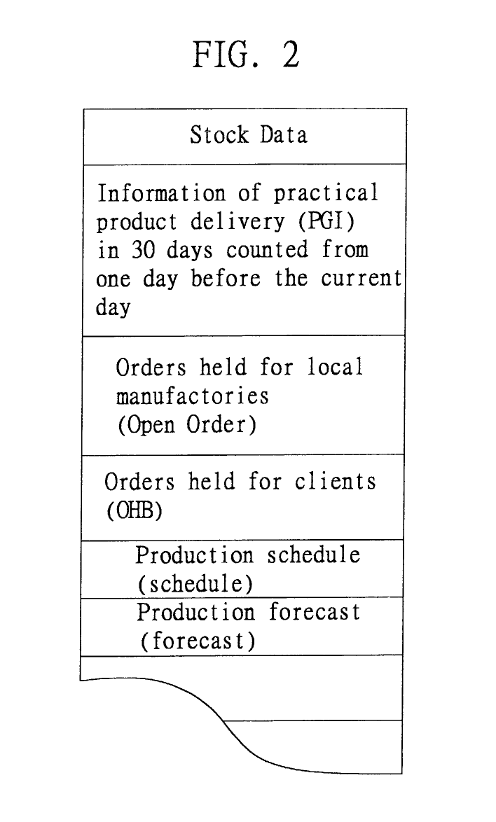

For uploading data to the network server 2 and the data server 3, the user at the terminal device 1 inputs data to a data uploading form 111 transmitted from the network server 2 and displayed in the browser 11. The data to be uploaded may include for example, orders held for local manufactories (named as “open orders”), orders held for clients (named as “OHB”), production schedule (abbreviated as “schedule”), production forecast (abbreviated as “forecast”), information of practical product delivery (named as “PGI”) in a number of certain days e.g. 30 days that is counted from one day before the current day, and stock data, as shown in FIG. 2. Then, the data uploading form 111 with the inputted data is transmitted to the network server 2 through the network communication system 4. Upon receiving the data uploading form 111, the processing module 20 of the network server 2 retrieves data including open orders, OHB, schedule, forecast, PGI and stock data uploaded via the data uploading form 111, and transmits the retrieved data to the uploading module 22 for data processing. The uploading module 22 analyses and processes the data, and then transmits the processed data to the database server 3. Upon data receiving, the database server stores the received data in a database 31 thereof.

The uploaded data from the user, for example, open orders, OHB, schedule, forecast, PGI and stock data, can be presented in text format (.txt) or Excel format (.xls), which are analyzed and processed by the uploading module for being uploaded to the database server 3 and stored in the database 31. Among the uploaded data, the stock data includes stock in transfer, block (defective products), purge (good quality products), and stock of materials in a warehouse.

The network server 2 regularly retrieves data stored in the database 31 of the database server 3, for allowing the user to obtain material inventory associated data. Before transmitting data to the user, a calculating module 23 of the network server 2 periodically retrieves data from the database 31 of the database server 3 for data processing, so as to calculate and integrate associated numeric and quantitative data to form a material inventory report that is to be stored in a report database 24 of the network server 2, for allowing the user to retrieve material inventory related data from the network server 2. In other words, when the processing module 20 receives a data retrieval request from the browser 11 of the terminal device 1, the network server 2 retrieves an inventory report form 112 from the form module 21, and transmits the inventory report form 112, that contains material inventory data stored in the report database 24, to the terminal device 1 through the network communication system 4. In addition, when the processing module 20 receives a data inquiry request from the browser 11 of the terminal device 1, the network server 2 retrieves an inquiry inputting form 113 from the form module 21, and transmits it to the terminal device I through the network communication system 4, allowing the user to input inquiry data items or categories to the inquiry inputting form 113 displayed in the browser 11. The inquiry data items or categories include for example, the number of days that stock can supply (Daily on Hand, DOH), total stock of materials and products (including stock in transfer, block and purge), daily demand, trend of product delivery, and OHB. When the user submits a form of the inquiry data items or categories to the network server 2, a retrieving module 25 is prompted to retrieve corresponding data from the report database 24 according to the inquiry data items or categories. The network server 2 retrieves an inventory report form 112 from the form module 21, and transmits the inventory report form 112, that contains the corresponding data inquired by the user, to the terminal device 1 through the network communication system 4.

In the system for maintaining efficient material inventory of the invention, a calculating module 23 of the system has been programmed for calculating safe inventory of materials and products in a certain number of days (described later on). Thus, when the system regularly retrieves data of open orders, OHB, schedule, forecast, PGI and stock data from a database server 3 that are uploaded by a user through a terminal device 1, the calculating module 23 can figure out material inventory associated data by analyzing and integrating the uploaded data. This allows easy inventory data communication between an enterprise and its overseas manufactories, so as to effectively control and maintain efficient stock of materials and products.

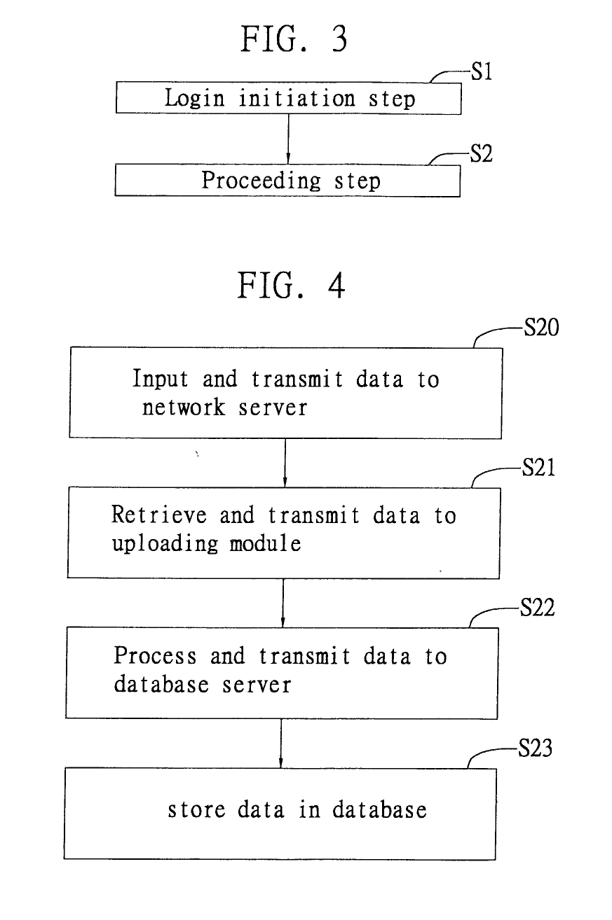

Referring to FIG. 3, it illustrates a method for maintaining efficient material inventory in the use of the system for maintaining efficient material inventory of the invention. The following description is made with reference to FIGS. 2 and 3.

As shown in FIG. 3, first in step S1 of a login initiation step, a user at a terminal device 1 uses a browser 11 of the terminal device I for submitting a login request to a network server 2 through a network communication system 4 so as to establish connection between the terminal device 1 and the network server 2, and login in the network server 2. Then, it proceeds to step S2.

In step S2 of a proceeding step, the browser 11 of the terminal device 1 receives at least a data uploading form 111, a inventory report form 112 and an inquiry inputting form 113 from the network server 2, allowing the user to use these forms for uploading data, retrieving material inventory data and checking inventory status of materials and products, respectively.

Referring to FIG. 4, it illustrates detailed procedures for describing a proceeding step in FIG. 3. As shown in the drawing, this embodiment allows a user to upload data, wherein the data to be uploaded include at least open orders, OHB, schedule, forecast, PGI and stock data, etc. First in step S20, the user at a terminal device 1 inputs data to a data uploading form 111 that is transmitted from a network server 2 and displayed in a browser 11 of the terminal device 1. Then, the data uploading form 111 with the inputted data is transmitted to the network server 2 through a network communication system 4. Then, step S21 is proceeded.

In step S21, upon receiving the data uploading form 111, a processing module 20 of the network server 2 reads and transmits the uploaded data including open orders, OHB, schedule, forecast, PGI and stock data, to an uploading module 22 for data processing. Next, step S22 is proceeded.

In step S22, upon receiving data from the processing module 20, the uploading module 22 analyzes and processes the received data, and then transmits the processed data to a database server 3. Then, step S23 is proceeded.

In step S23, the database server 3 stores the processed data into a database 31 thereof.

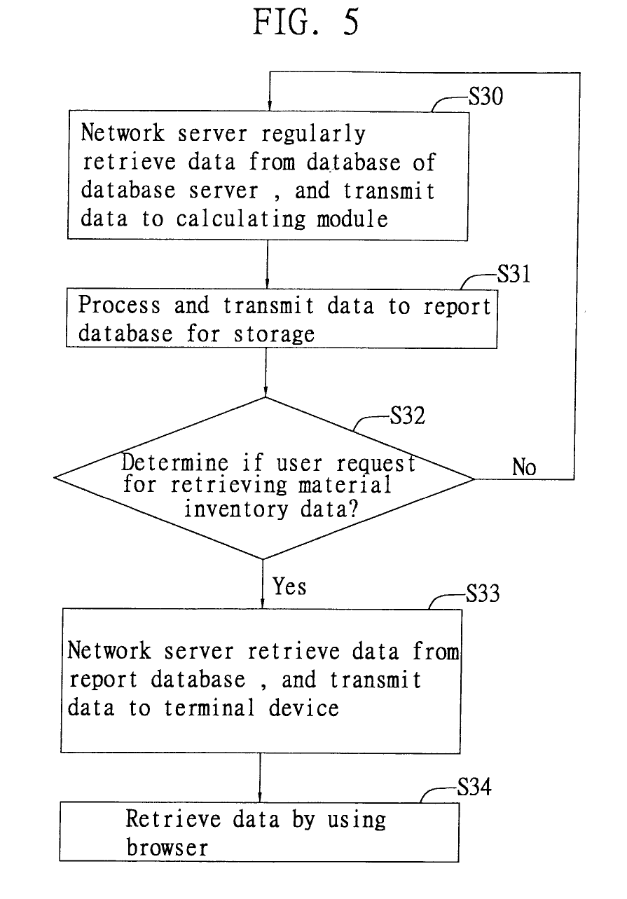

Referring to FIG. 5, it illustrates another embodiment of detailed procedures for describing a proceeding step in FIG. 3. As shown in the drawing, this embodiment allows a user to retrieve material inventory data. First in step S30, a network server 2 regularly retrieves data stored in a database 31 of a database server 3, and then transmits the retrieved data to a calculating module 23, where the retrieved data are calculated and integrated to generate a material inventory report. Then, the material inventory report is stored in a report database 24 of the network server 2. Thereafter, step S32 is proceeded.

In step S32, a processing module 20 of the network server 2 determines if the user at a terminal device 1 submits a request for retrieving material inventory data If the data retrieval request is submitted, then step S33 is proceeded; or else, the step S30 is returned.

In step S33, upon receiving the data retrieval request from a browser 11 of the terminal device 1, the network server 2 retrieves an inventory report form 112 from a form module 21 thereof, and assign the inventory report form 112 with material inventory data stored in the report module 24, so as to transmit the inventory report form 112 with material inventory data to the terminal device 1 through a network communication system 4. Then, step S34 is proceeded.

In step S34, the network server 2 transmits the inventory report form 112 to the browser 11 of the terminal device 1 through the network communication system 4, for allowing the user to retrieve the material inventory data

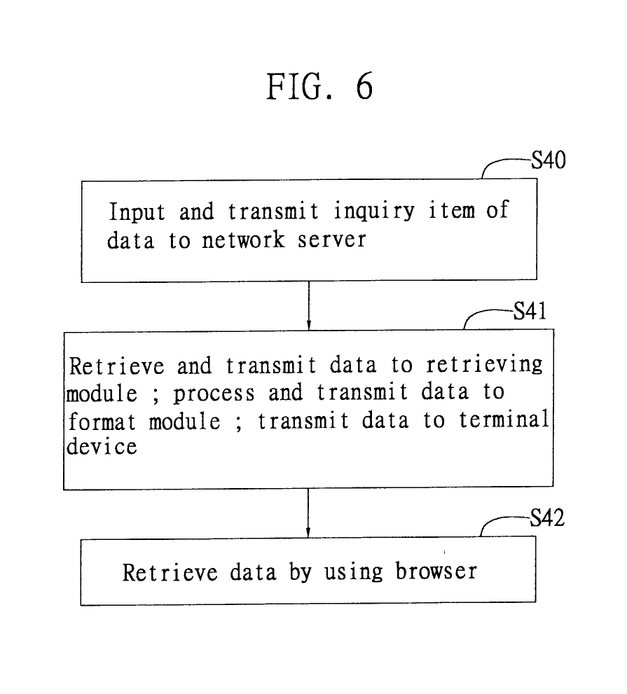

Referring to FIG. 6, it illustrates detailed description of FIG. 5 after step S31. As shown in the drawing, this embodiment allows a user to input inquiry data conditions and obtain corresponding material inventory data as inquired. First in step S40, when a processing module 20 of a network server 2 receives a data inquiry request from a browser 11 of a terminal device 1, the network server 2 retrieves an inquiry inputting form 113 from a form module 21 thereof, and then transmits it to the terminal device I through a network communication system 4. The user can input inquiry data items and conditions to the inquiry inputting form 113 displayed in the browser 11, including for example, at least a number of days that current stock can supply (DOH), total stock (such as stock in a warehouse, stock in transfer, block and purge), daily demand, product delivery trend, and OHB. The inputted inquiry conditions by the user are transmitted to the network server 2. Then, step S41 is proceeded.

In step S41, a retrieving module 25 of the network server 2 is prompted to read the inquiry conditions, and retrieve corresponding data from a report database 24. And, the network server 2 retrieves a inventory report form 112 that contains the corresponding data inquired by the user, and transmits it to the terminal device 1 through the network communication system 4. Then, step S42 is proceeded.

In step S42, the network server 2 transmits the inventory report form 112 through the network communication system 4 to the browser 11 of the terminal device 1, for allowing the user to retrieve the inquired data.

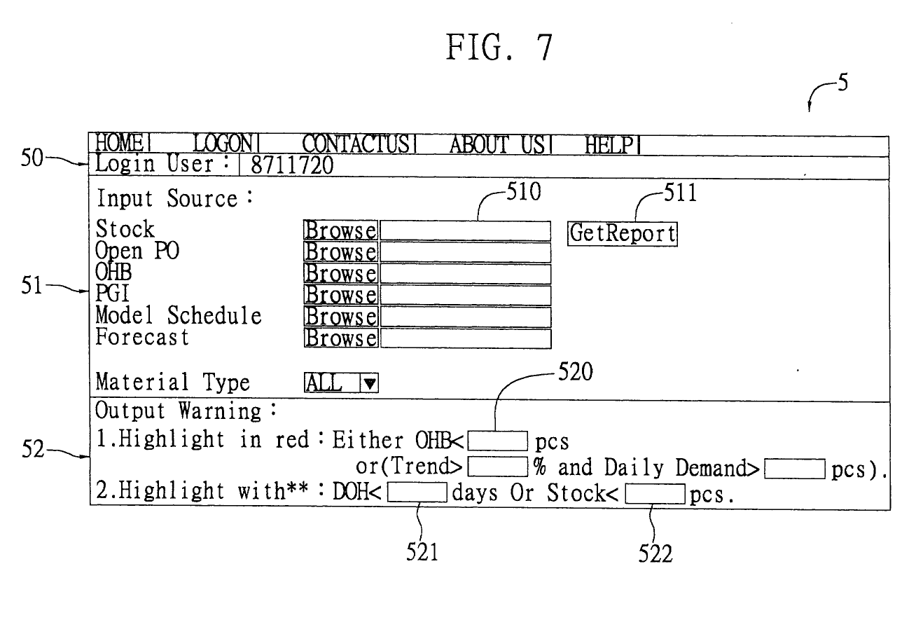

Referring to FIG. 7, it illustrates a practical example of a display page operated by a user in the use of a method and a system for maintaining efficient material inventory of the invention. As shown in the drawing, this embodiment shows a display page 5 for allowing a user at a terminal device I to inquiry material inventory data. The display page 5 comprises at least a column 50 for displaying the login user, an input source 51 where the user inputs inquiry data items, and an output warning 52 where the user inputs inquiry data conditions. This display page 5 is transmitted from a network server 2 to a browser 11 of the terminal device 1 through a network communication system 4. The user keys in the inquiry data items into browse columns 510 of the input source 51, or inputs the inquiry data conditions to columns 521, 522 of the output warning 52. Then, the user clicks on a get report button 511 for prompting retrieval of corresponding a material inventory report form a report database 24 of the network server 2 according to inquired data items or conditions.

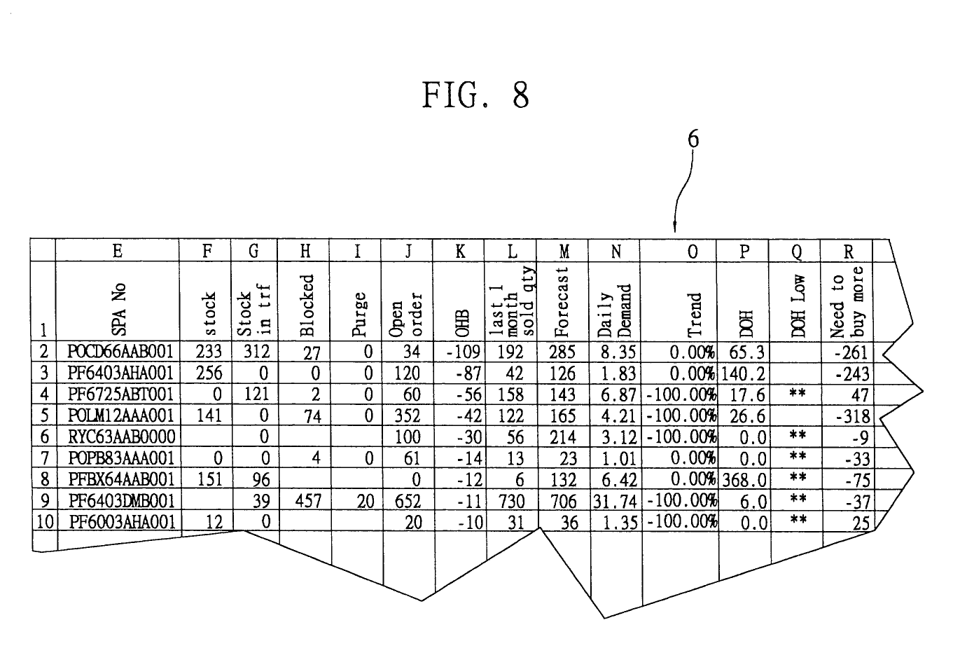

Referring to FIG. 8, it illustrates a practical example of using a method and a system for maintaining efficient material inventory of the invention, for providing a user with a display page 6 of an inventory report form. The display page 6 is a report form generated by the user operating a display page 5 in FIG. 7. For example, if the user keys in 25 into the column 521 of the input source 51 and 10 into the column 522 of the output warning 52 in the display page 5, this results in a material inventory report in the display page 6 with DOH<25 or stock<10 materials being indicated by ┘ **┌ symbols as shown in column Q at No. 4, 6, 7, 8, 9 and 10 fields of FIG. 8. This notifies the users to organize timely procurement of the materials with DOH<25 (stock amount can only support less than 25 days) or stock<10 (stock number is less than 10).

Data in columns (F, G, H, I, J, K, L, M) of the display page 6 are numeric and quantitative data obtained by a calculating module 23 of a network server 2 analyzing and integrating uploaded data stored in a database server 3. The calculating module 23 is programmed with formulae for calculating and processing the numeric and quantitative data, so as to obtain numeric values shown in columns N, O, P and R of the display page 6, wherein the formulae for calculation are listed in a table as follows.

| Column/Name | Formulae |
|---|---|
| N/Daily Demand | = Past month sale quantity ÷ Actual working days |
| | (around 22-23 days) |
| O/Trend | = [demand5 − (demand20 − demand5) ÷ 3] ÷ |
| | (demand20 − demand5) ÷ 3), wherein demand5 = last |
| | 5 days PGI quantity, demand20 = last 20 days PGI |
| | quantity, but if the demand20 − demand5 = 0, then |
| | Trend is set to 0. |
| | Remark: last 5 days PGI quantity = PGI quantity in |
| | 5 days counted from one day before the current day |
| P/DOH | = (Stock + Stock in Transfer) ÷ Daily Demand |
| R/Need to buy | = (Daily Demand × 25 − OHB) − (Stock + Stock in |
| more | Transfer + Open Order) |

Therefore, in the use of a method and a system for maintaining efficient material inventory of the invention, an enterprise can be immediate informed of material stock insufficiency, allowing material replenishment to be timely implemented. Also, the enterprise can monitor material inventory statuses of its overseas manufactories, and properly organize and manage material stock between the manufactories, so as to prevent the occurrence of delay in product manufacture and delivery due to insufficient material supply.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for maintaining efficient material inventory, in which data related to material stock and product orders from manufactories of an enterprise are stored through a network into a database server, and the stored data are processed and integrated to generate a report of current material inventory conditions, so as to manage and procure materials according to the report for maintaining safe material inventory; the method comprising the steps of:
(1) submitting a login request to a network server via a user by using a browser of a terminal device, for establishing connection between the network server and the terminal device through a network; and
(2) receiving via the browser of the terminal device at least a form from the network server, and proceeding corresponding procedures.

2. The method of claim 1, wherein the step (2) further comprises the steps of:
(2-1) receiving via the browser of the terminal device a data uploading form from the network server, and inputting data to the data uploading form via the user at the terminal device for transmitting the data uploading form with inputted data to the network server;
(2-2) retrieving and analyzing via the network server data in the data uploading form from the terminal device, and transmitting the analyzed data to the database server; and
(2-3) storing via the database server the analyzed data from the network server into a database of the database server.

3. The method of claim 2, after the step (2-3), further comprising the steps of:
(2-4) retrieving regularly via the network server data from the database of the database server, and processing the retrieved data by calculating and integrating associated numeric and quantitative data to form a material inventory report that is to be stored in a report database of the network server;
(2-5) determining via the network server if the user at the terminal device submits a request for retrieving material inventory data, wherein if the data retrieval request is submitted, then step (2-6) is proceeded; or else, the step (2-4) is returned; and
(2-6) retrieving and assigning an inventory report form via the network server with material inventory data stored in the report database, and transmitting the inventory report form with material inventory data to the terminal device through the network, allowing the user to obtain the material inventory data by using the browser of the terminal device.

4. The method of claim 2, after the step (2-3), further comprising the steps of:
(2-4) retrieving regularly via the network server data from the database of the database server, and processing the retrieved data by calculating and integrating associated numeric and quantitative data to form a material inventory report that is to be stored in a report database of the network server;
(2-5) determining via the network server if the user at the terminal device submits a request for inquiring material inventory, wherein if the inquiry request is submitted, then step (2- 6) is proceeded; or else, the step ( 2- 4) is returned;
(2-6) retrieving and transmitting an inquiry inputting form via the network server to the terminal device through the network, allowing the user to input inquiry data items and conditions to the inquiry inputting form displayed in the browser of the terminal device; and
(2-7) reading via the network server the inquiry data items and conditions in the inquiry inputting form transmitted from the user, and retrieving corresponding data from the report database according to the inquiry data items and conditions; obtaining and assigning an inventory report form via the network server with the retrieved corresponding data, so as to transmit the inventory report form to the terminal device through the network, allowing the user to acquire inquired material inventory data by using the browser of the terminal device.

5. The method of claim 2, wherein the data include orders held for local manufactories, orders held for clients, product schedule, production forecast, practical product delivery quantity in a certain number of days counted from one day before a current day, and stock data.

6. The method of claim 5, wherein the data are presented in text format or in Excel format.

7. The method of claim 5, wherein the stock data include stock in transfer, defective stock, good quality stock, and material stock stored in a warehouse.

8. The method of claim 4, wherein the inquiry data items and conditions include a number of days supportable by stock, stock data, daily demand, product delivery trend, and orders held for clients.

9. A system for maintaining efficient material inventory, in which data related to material stock and product orders from manufactories of an enterprise are organized for storage, and the stored data are analyzed and integrated to generate a report of current material inventory conditions, so as to manage and procure materials according to the report for maintaining safe material inventory; the system comprising:
a terminal device having a browser, allowing a user at the terminal device to use the browser for logging in a network server through a network, wherein the browser receives at least a form from the network server, allowing the user to upload data, retrieve material inventory data or inquire desired material data according to the form, and corresponding results are displayed in the form on the browser;
the network server for generating a corresponding form according to a request from the user who logins in the network server, and transmitting the form to the terminal device of the user; wherein for uploading data, the network server receives a form containing data uploaded from the terminal device and processes the uploaded data in association with a database server; wherein before the user retrieves material inventory data, the network server regularly retrieves data from a database of the database server, and processes associated retrieved data so as to store the processed data in a database of the network server; wherein when the user requests for retrieving material inventory data, the network server retrieves an inventory report form from the database thereof, and transmits it to the browser of the terminal device for display; wherein when the user requests for inquiring data items or conditions, the network server receives a form containing the inquiry data items or conditions, and retrieves corresponding material inventory data, which are transmitted to the browser of the terminal device for display; and
the database server for receiving data from the network server and processing the data for storage.

10. A system for maintaining efficient material inventory, in which data related to material stock and product orders from manufactories of an enterprise are organized for storage, and the stored data are analyzed and integrated to generate a report of current material inventory conditions, so as to manage and procure materials according to the report for maintaining safe material inventory; the system comprising:
a terminal device having a browser, allowing a user at the terminal device to use the browser for logging in a network server through a network, wherein the browser receives at least a form from the network server, allowing the user to upload data, retrieve material inventory data or inquire desired material data according to the form, and corresponding results are displayed in the form on the browser;
the network server for generating a corresponding form according to a request from the user who logins in the network server, and transmitting the form to the terminal device of the user; and for proceeding according to the form returned from the user and transmitting corresponding results to the terminal device; wherein the network server includes a processing module, a form module, an uploading module, a calculating module, a report database and a retrieving module;
the processing module for receiving a request from the user at the terminal device who logins in the network server, and retrieving a corresponding form from the form module according to the received request so as to transmit the retrieved form to the terminal device; for retrieving data in a form from the terminal device and transmitting the data to the uploading module for data processing; and for retrieving inquiry data items or conditions in a form from the terminal device, and transmitting the inquiry data items or conditions to the retrieving module for processing;
the form module having various forms used for the user at the terminal device to upload data, retrieve material inventory data and inquire desired material data, and for allowing the processing module, the uploading module, the calculating module, the report database and the retrieving module to retrieve the forms;
the uploading module for receiving data from the processing module, and transmitting the data to a database server for storage;
the calculating module for regularly retrieving data from the database server and processing the retrieved data so as to store the processed data into the report database;
the report database for storing material inventory associated data obtained by the calculating module processing data in the database server;
the retrieving module for receiving inquiry data items or conditions from the processing module, and retrieving data from the report database so as to transmit the retrieve data to the processing module; and
the database server having a database that stores data from the uploading module and provides material inventory data for the calculating module.

11. The method of claim 9, wherein the data include orders held for local manufactories, orders held for clients, product schedule, production forecast, practical product delivery quantity in a certain number of days counted from one day before a current day, and stock data.

12. The method of claim 10, wherein the data include orders held for local manufactories, orders held for clients, product schedule, production forecast, practical product delivery quantity in a certain number of days counted from one day before a current day, and stock data.

13. The method of claim 11, wherein the stock data include stock in transfer, defective stock, good quality stock, and material stock stored in a warehouse.

14. The method of claim 12, wherein the stock data include stock in transfer, defective stock, good quality stock, and material stock stored in a warehouse.

15. The method of claim 9, wherein the inquiry data items and conditions include a number of days supportable by stock, stock data, daily demand, product delivery trend, and orders held for clients.

16. The method of claim 10, wherein the inquiry data items and conditions include a number of days supportable by stock, stock data, daily demand, product delivery trend, and orders held for clients.
